(19) United States
(12) Patent Application Publication
(10) Pub. No.: US 2026/0302941 A1
(43) Pub. Date: Oct. 1, 2026

(54) ELECTRIC POWER SOURCE SYSTEM

(71) Applicant: HONDA MOTOR CO., LTD., Tokyo (JP)

(72) Inventor: Yaolu Zou, Tokyo (JP)

(21) Appl. No.: 19/547,729

(22) Filed: Feb. 24, 2026

(30) Foreign Application Priority Data
Mar. 25, 2025 (JP) 2025-049373

(51) Int. Cl. H02M 3/155; H02J 1/10

(52) U.S. Cl. CPC H02M 3/155; H02J 1/10

(57) ABSTRACT

An electric power source system includes: a first DC electric power source having a positive electrode terminal connected to a first node; a second DC electric power source having a negative electrode terminal connected to a second node; a first contactor connected between the first node and a third node; a second contactor connected between the second node and a fourth node; a third contactor connected between a negative electrode terminal of the first DC electric power source and a fifth node; a fourth contactor connected between a positive electrode terminal of the second DC electric power source and a sixth node; a first switch connected between the third node and the sixth node; a second switch connected between the fifth node and the sixth node; a third switch connected between the fourth node and the fifth node; a first voltage conversion circuit connected between the first node and the fourth node; and a second voltage conversion circuit connected between the second node and the third node.

### CROSS-REFERENCE TO RELATED APPLICATION

Priority is claimed on Japanese Patent Application No. 2025-049373, filed on Mar. 25, 2025, the contents of which are incorporated herein by reference.

### BACKGROUND

### Field of the Invention

The present invention relates to an electric power source system.

### Background

Japanese Unexamined Patent Application, First Publication No. 2014-003858 discloses an electric power source device that can switch a series state in which a first electric power source, a second electric power source, and a reactor are connected to an inverter in series and a parallel state in which the first electric power source and the second electric power source are connected to the inverter in parallel.

### SUMMARY

Japanese Unexamined Patent Application, First Publication No. 2014-003858 does not describe a configuration for continuing to supply electric power from the electric power source device when a failure occurs in a load device to which electric power is supplied from the electric power source device.

An electric power source system according to a first aspect of the present invention includes: a first DC electric power source having a positive electrode terminal connected to a first node; a second DC electric power source having a negative electrode terminal connected to a second node; a first contactor connected between the first node and a third node; a second contactor connected between the second node and a fourth node; a third contactor connected between a negative electrode terminal of the first DC electric power source and a fifth node; a fourth contactor connected between a positive electrode terminal of the second DC electric power source and a sixth node; a first switch connected between the third node and the sixth node; a second switch connected between the fifth node and the sixth node; a third switch connected between the fourth node and the fifth node; a first voltage conversion circuit connected between the first node and the fourth node; and a second voltage conversion circuit connected between the second node and the third node.

A second aspect is the electric power source system according to the first aspect described above which may further include: a fourth switch connected between a seventh node and an output terminal of the first voltage conversion circuit; and a fifth switch connected between the seventh node and an output terminal of the second voltage conversion circuit.

A third aspect is the electric power source system according to the first aspect described above which may further include: a fifth contactor connected between the first node and the first voltage conversion circuit, wherein a rating of the fifth contactor may be smaller than a rating of the first contactor.

A fourth aspect is the electric power source system according to the first aspect described above which may further include: a sixth contactor connected between the second node and the second voltage conversion circuit, wherein a rating of the sixth contactor may be smaller than a rating of the second contactor.

A fifth aspect is the electric power source system according to the first aspect described above which may further include: a control device, wherein when the control device detects that a failure occurs in a first load device connected between the third node and the fourth node, the control device may control the first contactor, the second contactor, and the fourth contactor to an OFF state, control the third contactor to an ON state, control the first switch and the third switch to an ON state, and control the second switch to an OFF state.

A sixth aspect is the electric power source system according to the first aspect described above which may further include: a control device, wherein when the control device detects that a failure occurs in a first load device connected between the third node and the fourth node, the control device may control the first contactor, the second contactor, and the third contactor to an OFF state, control the fourth contactor to an ON state, control the first switch and the third switch to an ON state, and control the second switch to an OFF state.

A seventh aspect is the electric power source system according to the first aspect described above which may further include: a control device, wherein when the control device detects that a failure occurs in a first load device connected between the third node and the fourth node, the control device may control the first contactor and the second contactor to an OFF state, control the third contactor and the fourth contactor to an ON state, control the first switch and the third switch to an ON state, and control the second switch to an OFF state.

According to the first aspect, for example, even when a failure such as an overcurrent occurs in a first load device connected between the third node N3 and the fourth node N4, at least one of the first voltage conversion circuit and the second voltage conversion circuit can continue to operate, and therefore, it is possible to continue to maintain electric power supply from the electric power source system.

According to the second aspect, even when any one of the first voltage conversion circuit and the second voltage conversion circuit fails, for example, it is possible to continue to supply electric power to a second load device connected to the seventh node.

According to the third aspect, since a wiring that connects the first node to the first voltage conversion circuit is a wiring dedicated to an electric power source used for a control device, the rating of the fifth contactor provided on the wiring can be lower than that of a contactor used for a large electric power load such as a motor. Thereby, it is possible to realize reduction of the size and reduction of the cost of the electric power source system.

According to the fourth aspect, since a wiring that connects the second node to the second voltage conversion circuit is a wiring dedicated to an electric power source used for a control device, the rating of the sixth contactor provided on the wiring can be lower than that of a contactor used for a large electric power load such as a motor. Thereby, it is possible to realize reduction of the size and reduction of the cost of the electric power source system.

According to the fifth aspect, for example, even when a failure such as an overcurrent occurs in the first load device connected between the third node and the fourth node, the first voltage conversion circuit can continue to operate while electrically disconnecting the first DC electric power source and the second DC electric power source from the first load device.

According to the sixth aspect, for example, even when a failure such as an overcurrent occurs in the first load device connected between the third node and the fourth node, the second voltage conversion circuit can continue to operate while electrically disconnecting the first DC electric power source and the second DC electric power source from the first load device.

According to the seventh aspect, for example, even when a failure such as an overcurrent occurs in the first load device connected between the third node and the fourth node, both of the first voltage conversion circuit and the second voltage conversion circuit can continue to operate while electrically disconnecting the first DC electric power source and the second DC electric power source from the first load device.

### BRIEF DESCRIPTION OF THE DRAWINGS

FIG. 1 is a view showing a schematic configuration of an electric power source system according to an embodiment.

FIG. 2 is a view showing states of each switch and each contactor when the electric power source system according to the embodiment operates in a series mode.

FIG. 3 is a view showing states of each switch and each contactor when the electric power source system according to the embodiment operates in a parallel mode.

FIG. 4A is a view showing a current path when the electric power source system according to the embodiment is operating in a warming mode.

FIG. 4B is a view showing a current path when the electric power source system according to the embodiment is operating in the warming mode.

FIG. 4C is a view showing a current path when the electric power source system according to the embodiment is operating in the warming mode.

FIG. 5 is a view showing a change in a current when the electric power source system according to the embodiment is operating in the warming mode.

FIG. 6 is a view showing a relationship between an amplitude of a current that flows when the electric power source system according to the embodiment is operating in the warming mode and a ratio (T/Tf).

FIG. 7A is a view showing a current path when the electric power source system according to the embodiment is operating in a first voltage balance mode.

FIG. 7B is a view showing a current path when the electric power source system according to the embodiment is operating in the first voltage balance mode.

FIG. 8 is a view showing a change in a current when the electric power source system according to the embodiment is operating in the first voltage balance mode.

FIG. 9A is a view showing a current path when the electric power source system according to the embodiment is operating in a second voltage balance mode.

FIG. 9B is a view showing a current path when the electric power source system according to the embodiment is operating in the second voltage balance mode.

FIG. 10 is a view showing a change in a current when the electric power source system according to the embodiment is operating in the second voltage balance mode.

FIG. 11 is a flowchart showing a process when a voltage balance control is performed in the electric power source system according to the embodiment.

FIG. 12 is a first view showing states of each switch and each contactor when the electric power source system according to the embodiment operates in a fail-safe mode.

FIG. 13 is a second view showing states of each switch and each contactor when the electric power source system according to the embodiment operates in the fail-safe mode.

FIG. 14 is a third view showing states of each switch and each contactor when the electric power source system according to the embodiment operates in the fail-safe mode.

### DESCRIPTION OF EMBODIMENTS

Hereinafter, an embodiment of an electric power source system according to the present invention will be described with reference to the drawings.

### <Electric Power Source System>

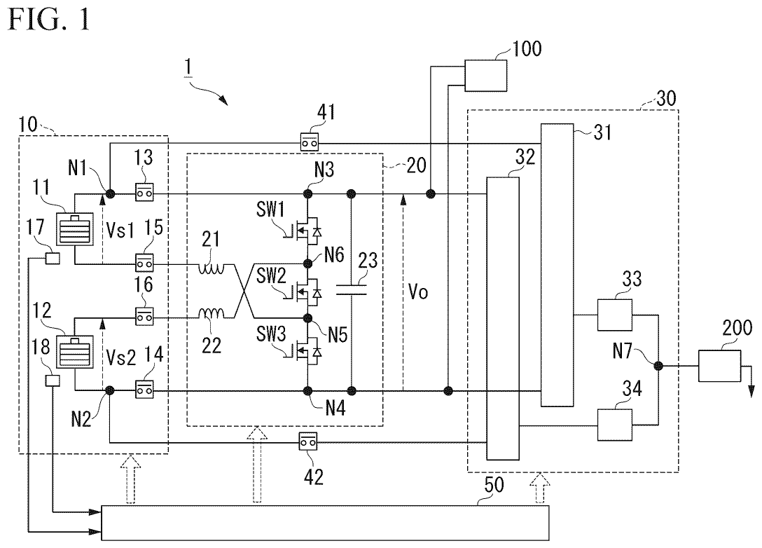

FIG. 1 is a view showing a schematic configuration of an electric power source system 1 according to the present embodiment. As shown in FIG. 1, the electric power source system 1 includes an electric power source unit 10, an electric power source switching circuit 20, a voltage conversion unit 30, a fifth contactor 41, a sixth contactor 42, and a control device 50.

For example, the electric power source system 1 is mounted on an electric vehicle and supplies DC electric power to a plurality of devices in the electric vehicle.

The electric power source unit 10 includes a first DC electric power source 11, a second DC electric power source 12, a first contactor 13, a second contactor 14, a third contactor 15, a fourth contactor 16, a first voltage sensor 17, and a second voltage sensor 18. Each of the first DC electric power source 11 and the second DC electric power source 12 is a rechargeable secondary battery such as a battery.

The first DC electric power source 11 has a positive electrode terminal electrically connected to a first node N1 and a negative electrode terminal electrically connected to one end of the third contactor 15. The second DC electric power source 12 has a positive electrode terminal electrically connected to one end of the fourth contactor 16 and a negative electrode terminal electrically connected to a second node N2.

The first contactor 13 is electrically connected between the first node N1 and a third node N3. The second contactor 14 is electrically connected between the second node N2 and a fourth node N4. The third contactor 15 is connected between a fifth node N5 and the negative electrode terminal of the first DC electric power source 11. The fourth contactor 16 is connected between a sixth node N6 and the positive electrode terminal of the second DC electric power source 12.

Although not shown in FIG. 1, each contactor included in the electric power source unit 10 is electrically connected to the control device 50. The state of each contactor included in the electric power source unit 10 is switched between an ON state and an OFF state by the control device 50.

The first voltage sensor 17 detects a voltage Vs1 of the first DC electric power source 11 and outputs a signal indicating the detection result to the control device 50.

The second voltage sensor 18 detects a voltage Vs2 of the second DC electric power source 12 and outputs a signal indicating the detection result to the control device 50.

The electric power source switching circuit 20 includes a first switch SW1, a second switch SW2, a third switch SW3, a first reactor 21, a second reactor 22, and a smoothing capacitor 23. For example, the first switch SW1, the second switch SW2, and the third switch SW3 are an n-channel type MOS-FET (Metal-Oxide-Semiconductor Field-Effect Transistor).

The first switch SW1 is electrically connected between the third node N3 and the sixth node N6. Specifically, the first switch SW1 has a drain terminal electrically connected to the third node N3 and a source terminal electrically connected to the sixth node N6.

The second switch SW2 is electrically connected between the fifth node N5 and the sixth node N6. Specifically, the second switch SW2 has a drain terminal electrically connected to the sixth node N6 and a source terminal electrically connected to the fifth node N5.

The third switch SW3 is electrically connected between the fourth node N4 and the fifth node N5. Specifically, the third switch SW3 has a drain terminal electrically connected to the fifth node N5 and a source terminal electrically connected to the fourth node N4.

Although not shown in FIG. 1, a gate terminal of each switch included in the electric power source switching circuit 20 is electrically connected to the control device 50. As described later, a gate signal which is a pulse signal on which pulse width modulation is applied is supplied from the control device 50 to the gate terminal of each switch included in the electric power source switching circuit 20.

The first reactor 21 is electrically connected between the third contactor 15 and the fifth node N5. The second reactor 22 is electrically connected between the fourth contactor 16 and the sixth node N6. The smoothing capacitor 23 is electrically connected between the third node N3 and the fourth node N4. A potential difference between the third node N3 and the fourth node N4 is an output voltage Vo of the electric power source switching circuit 20.

The voltage conversion unit 30 includes a first voltage conversion circuit 31, a second voltage conversion circuit 32, a fourth switch 33, and a fifth switch 34. For example, each of the first voltage conversion circuit 31 and the second voltage conversion circuit 32 is a DC/DC converter.

The first voltage conversion circuit 31 is electrically connected between the first node N1 and the fourth node N4. The second voltage conversion circuit 32 is electrically connected between the second node N2 and the third node N3. That is, when all of the contactors included in the electric power source unit 10 are in an ON state, the output voltage Vo of the electric power source switching circuit 20 is input to each of the first voltage conversion circuit 31 and the second voltage conversion circuit 32. Each of the first voltage conversion circuit 31 and the second voltage conversion circuit 32 outputs a DC voltage having a voltage value which is different from that of an input voltage.

The fourth switch 33 is electrically connected between a seventh node N7 and an output terminal of the first voltage conversion circuit 31. The fifth switch 34 is electrically connected between the seventh node N7 and an output terminal of the second voltage conversion circuit 32. Although not shown in FIG. 1, each switch included in the voltage conversion unit 30 is electrically connected to the control device 50. The state of each switch included in the voltage conversion unit 30 is switched between an ON state and an OFF state by the control device 50.

The fifth contactor 41 is electrically connected between the first node N1 and the first voltage conversion circuit 31. The rating of the fifth contactor 41 is smaller than that of the first contactor 13. The sixth contactor 42 is electrically connected between the second node N2 and the second voltage conversion circuit 32.

The rating of the sixth contactor 42 is smaller than that of the second contactor 14. Although not shown in FIG. 1, the fifth contactor 41 and the sixth contactor 42 are electrically connected to the control device 50. The states of the fifth contactor 41 and the sixth contactor 42 are switched between an ON state and an OFF state by the control device 50.

The control device 50 controls each switch included in the electric power source switching circuit 20 based on output signals of the first voltage sensor 17 and the second voltage sensor 18. Further, the control device 50 controls each contactor included in the electric power source unit 10, each switch included in the voltage conversion unit 30, the fifth contactor 41, and the sixth contactor 42.

For example, the electric power source system 1 having a configuration as described above supplies DC electric power to each of a first load device 100 and a second load device 200. The first load device 100 is electrically connected between the third node N3 and the fourth node N4. That is, the output voltage Vo of the electric power source switching circuit 20 is input to the first load device 100. For example, the first load device 100 is an E-Axle, an electric compressor, or the like mounted on an electric vehicle.

The second load device 200 is electrically connected to the seventh node N7.

That is, the output voltage of the first voltage conversion circuit 31 or the output voltage of the second voltage conversion circuit 32 is input to the second load device 200. When the fourth switch 33 is in an ON state and the fifth switch 34 is in an OFF state, the output voltage of the first voltage conversion circuit 31 is input to the second load device 200. When the fourth switch 33 is in an OFF state and the fifth switch 34 is in an ON state, the output voltage of the second voltage conversion circuit 32 is input to the second load device 200. For example, the second load device 200 is a vehicle control device, a battery, or the like mounted on the electric vehicle.

As described above, the electric power source system 1 of the present embodiment includes a redundant configuration capable of continuing to supply DC electric power to the second load device 200 even when any one of the first voltage conversion circuit 31 and the second voltage conversion circuit 32 fails.

The electric power source system 1 of the present embodiment has a parallel mode and a series mode as an operation mode. The parallel mode is a mode in which the first DC electric power source 11 and the second DC electric power source 12 operate in a state (parallel state) of being connected in parallel. The series mode is a mode in which the first DC electric power source 11 and the second DC electric power source 12 operate in a state (series state) of being connected in series. The control device 50 controls each switch included in the electric power source switching circuit 20 and thereby switches the operation mode between the parallel mode and the series mode.

Further, the electric power source system 1 has, as the operation mode, a warming mode, a voltage balance mode, and a fail-safe mode in addition to the parallel mode and the series mode. The warming mode is an operation mode in which the first DC electric power source 11 and the second DC electric power source 12 are warmed by a chopper method. The voltage balance mode is an operation mode in which the voltage of the first DC electric power source 11 and the voltage of the second DC electric power source 12 are equal to each other. When the voltage of the first DC electric power source 11 is different from the voltage of the second DC electric power source 12, a short-circuit current flows from one of the first DC electric power source 11 and the second DC electric power source 12 to the other of the first DC electric power source 11 and the second DC electric power source 12. In order to prevent this, the voltage balance mode is performed. The fail-safe mode is an operation mode for continuing electric power supply to the second load device 200 while preventing a circuit component in the electric power source system 1 from being damaged when a failure such as an overcurrent occurs in the first load device 100. The details of the operation mode and an operation state of the electric power source system 1 will be described later.

### <Series Mode and Parallel Mode>

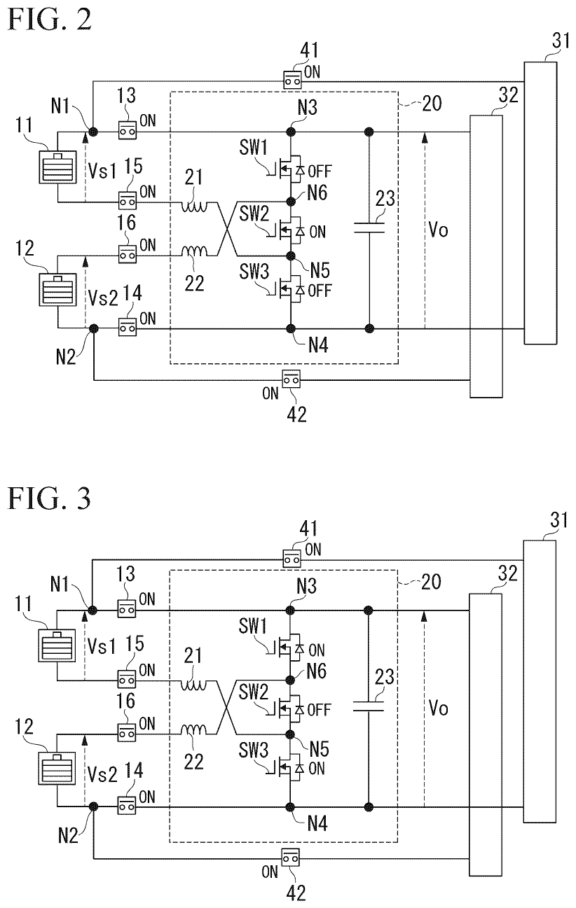

FIG. 2 is a view showing states of each switch and each contactor when the electric power source system 1 operates in the series mode. In FIG. 2, only configurations necessary for description are shown among the configurations shown in FIG. 1.

As shown in FIG. 2, in the series mode, the control device 50 controls each of the first contactor 13, the second contactor 14, the third contactor 15, the fourth contactor 16, the fifth contactor 41, and the sixth contactor 42 to an ON state, controls the first switch SW1 and the third switch SW3 to an OFF state, and controls the second switch SW2 to an ON state.

As a result, in the series mode, the first DC electric power source 11 and the second DC electric power source 12 are connected in series between the third node N3 and the fourth node N4. In this case, a potential difference between the third node N3 and the fourth node N4, that is, the output voltage Vo of the electric power source switching circuit 20 is expressed by Equation (1) described below. In this way, when the electric power source system 1 operates in the series mode, the output voltage Vo of the electric power source switching circuit 20 expressed by Equation (1) described below is input to each of the first voltage conversion circuit 31 and the second voltage conversion circuit 32.

Vo=Vs1+Vs2 (1)

FIG. 3 is a view showing states of each switch and each contactor when the electric power source system 1 operates in a parallel mode. In FIG. 3, only configurations necessary for description are shown among the configurations shown in FIG. 1.

As shown in FIG. 3, in the parallel mode, the control device 50 controls each of the first contactor 13, the second contactor 14, the third contactor 15, the fourth contactor 16, the fifth contactor 41, and the sixth contactor 42 to an ON state, controls the first switch SW1 and the third switch SW3 to an ON state, and controls the second switch SW2 to an OFF state.

As a result, in the parallel mode, the first DC electric power source 11 and the second DC electric power source 12 are connected in parallel between the third node N3 and the fourth node N4. In this case, the output voltage Vo of the electric power source switching circuit 20 is expressed by Equation (2) described below. In this way, when the electric power source system 1 operates in the parallel mode, the output voltage Vo of the electric power source switching circuit 20 expressed by Equation (2) described below is input to each of the first voltage conversion circuit 31 and the second voltage conversion circuit 32.

Vo=Vs1=Vs2 (2)

### <Warming Mode>

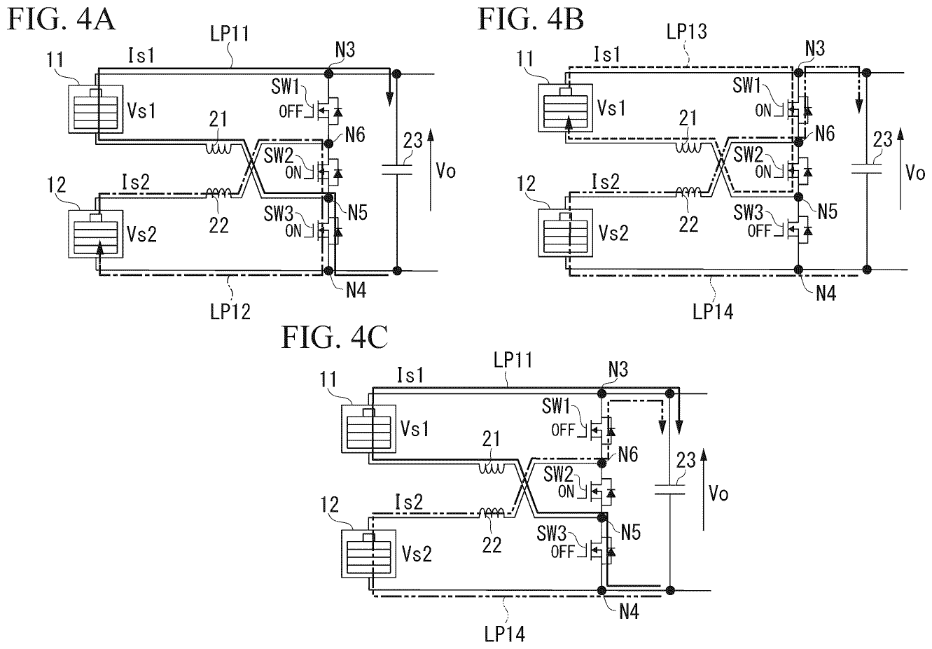

FIG. 4A to FIG. 4C are views showing a current path when the electric power source system 1 is operating in the warming mode. In FIG. 4A to FIG. 4C, only the configurations necessary for description are shown among the configurations shown in FIG. 1.

In the warming mode, the control device 50 controls the electric power source switching circuit 20 to alternately switch between a first state shown in FIG. 4A and a second state shown in FIG. 4B. The switching frequency between the first state and the second state is, for example, several tens to several hundreds of kHz.

In a period in which the electric power source system 1 is operating in the warming mode, the control device 50 controls each of the first contactor 13, the second contactor 14, the third contactor 15, the fourth contactor 16, the fifth contactor 41, and the sixth contactor 42 to an ON state.

Here, when switching from the first state shown in FIG. 4A to the second state shown in FIG. 4B, the control device 50 once switches the state to a third state shown in FIG. 4C and then switches the state to the second state shown in FIG. 4B. Further, when switching from the second state shown in FIG. 4B to the first state shown in FIG. 4A, the control device 50 once switches the state to the third state shown in FIG. 4C and then switches the state to the first state shown in FIG. 4A.

Here, the first state described above is a state in which the first DC electric power source 11 is connected between the third node N3 and the fourth node N4 via the first reactor 21, and the second DC electric power source 12 is connected to both ends of the second reactor 22. The second state described above is a state in which the second DC electric power source 12 is connected between the third node N3 and the fourth node N4 via the second reactor 22, and the first DC electric power source 11 is connected to both ends of the first reactor 21. The third state described above is a state in which the first DC electric power source 11 is connected between the third node N3 and the fourth node N4 via the first reactor 21, and the second DC electric power source 12 is connected between the third node N3 and the fourth node N4 via the second reactor 22. As can be seen from FIG. 4A to FIG. 4C, in the warming mode, at least one of the first DC electric power source 11 and the second DC electric power source 12 is connected between the third node N3 and the fifth node N5.

As shown in FIG. 4A, the control device 50 sets the first state described above by setting the first switch SW1 to an OFF state and setting the second switch SW2 and the third switch SW3 to an ON state.

In the first state, a current loop LP11 that passes through the third switch SW3, the first reactor 21, the first DC electric power source 11, and the smoothing capacitor 23 in this order is formed. Further, a current loop LP12 that passes through the second DC electric power source 12, the second reactor 22, the second switch SW2, and the third switch SW3 in this order is also formed. The current loop LP11 is a current path in a state where the first DC electric power source 11 is connected between the third node N3 and the fourth node N4 via the first reactor 21.

The current loop LP12 is a current path in a state where the second DC electric power source 12 is connected to both ends of the second reactor 22.

As shown in FIG. 4B, the control device 50 sets the second state described above by setting the first switch SW1 and the second switch SW2 to an ON state and setting the third switch SW3 to an OFF state.

In the second state, a current loop LP13 that passes through the first DC electric power source 11, the first switch SW1, the second switch SW2, and the first reactor 21 in this order is formed. Further, a current loop LP14 that passes through the second DC electric power source 12, the second reactor 22, the first switch SW1, and the smoothing capacitor 23 in this order is also formed. The current loop LP13 is a current path in a state where the first DC electric power source 11 is connected to both ends of the first reactor 21. The current loop LP14 is a current path in a state where the second DC electric power source 12 is connected between the third node N3 and the fourth node N4 via the second reactor 22.

As shown in FIG. 4C, the control device 50 sets the third state described above by setting the first switch SW1 and the third switch SW3 to an OFF state and setting the second switch SW2 to an ON state.

In the third state, the current loop LP11 shown in FIG. 4A and the current loop LP14 shown in FIG. 4B are formed. That is, in the third state, the first DC electric power source 11 and the second DC electric power source 12 are connected between the third node N3 and the fourth node N4 in parallel.

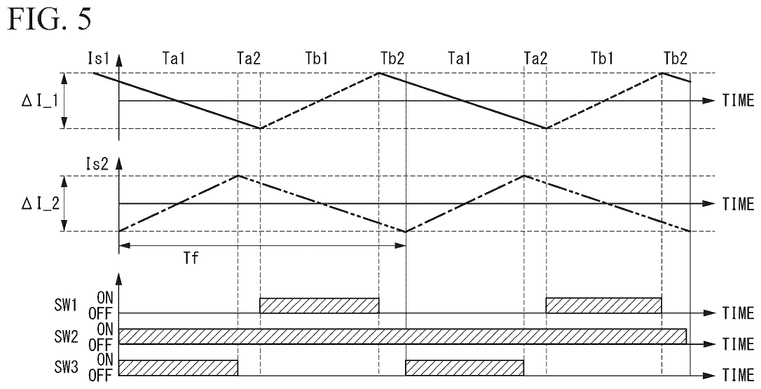

FIG. 5 is a view showing a change in a current when the electric power source system 1 is operating in the warming mode. In FIG. 5, a period in which the state is set to the first state shown in FIG. 4A is referred to as a period Ta1, and a period in which the state is set to the second state shown in FIG. 4B is referred to as a period Tb1. Further, when the state is switched from the first state shown in FIG. 4A to the second state shown in FIG. 4B, a period in which the state is once set to the third state shown in FIG. 4C is referred to as a period Ta2. Further, when the state is switched from the second state shown in FIG. 4B to the first state shown in FIG. 4A, a period in which the state is once set to the third state shown in FIG. 4C is referred to as a period Tb2.

As shown in FIG. 5, the control device 50 controls the first switch SW1, the second switch SW2, and the third switch SW3 and performs switching among the states shown in FIG. 4A to FIG. 4C. Specifically, the first state (period Ta1) shown in FIG. 4A, the third state (period Ta2) shown in FIG. 4C, the second state (period Tb1) shown in FIG. 4B, the third state (period Tb2) shown in FIG. 4C, the first state (period Ta1) shown in FIG. 4A, . . . are sequentially switched.

In the period Ta1 in which the state is set to the first state shown in FIG. 4A, the voltage Vs1 of the first DC electric power source 11 is lower than the output voltage Vo of the electric power source switching circuit 20. Therefore, as shown in FIG. 5, a current Is1 (a current that flows through the current loop LP11 shown in FIG. 4A) that flows through the first DC electric power source 11 is decreased. Specifically, when a reactance of the first reactor 21 is L1, a decrease rate of the current Is1 is expressed by dIs1/dt=(Vs1−Vo)/L1. On the other hand, the voltage Vs2 of the second DC electric power source 12 is higher than 0. Therefore, as shown in FIG. 5, the current Is2 (the current that flows through the current loop LP12 shown in FIG. 4A) that flows through the second DC electric power source 12 is increased. Specifically, when a reactance of the second reactor 22 is L2, an increase rate of the current Is2 is expressed by dIs2/dt=Vs2/L2.

In the period Tb1 in which the state is set to the second state shown in FIG. 4B, the voltage Vs1 of the first DC electric power source 11 is higher than 0. Therefore, as shown in FIG. 5, the current Is1 (the current that flows through the current loop LP13 shown in FIG. 4B) that flows through the first DC electric power source 11 is increased. Specifically, the increase rate of the current Is1 is expressed by dIs1/dt=Vs1/L1. On the other hand, the voltage Vs2 of the second DC electric power source 12 is lower than the output voltage Vo of the electric power source switching circuit 20. Therefore, as shown in FIG. 5, the current Is2 (the current that flows through the current loop LP14 shown in FIG. 4B) that flows through the second DC electric power source 12 is decreased. Specifically, the decrease rate of the current Is2 is expressed by dIs2/dt=(Vs2−Vo)/L2.

In the period Ta2 and the period Tb2 in which the state is set to the third state shown in FIG. 4C, both of the voltage Vs1 of the first DC electric power source 11 and the voltage Vs2 of the second DC electric power source 12 are lower than the output voltage Vo of the electric power source switching circuit 20. Therefore, as shown in FIG. 5, the current Is1 (the current that flows through the current loop LP11 shown in FIG. 4C) that flows through the first DC electric power source 11 and the current Is2 (the current that flows through the current loop LP14 shown in FIG. 4C) that flows through the second DC electric power source 12 are decreased. Specifically, the decrease rate of the current Is1 is expressed by dIs1/dt=(Vs1−Vo)/L1, and the decrease rate of the current Is2 is expressed by dIs2/dt=(Vs2−Vo)/L2.

Here, the voltage Vs1 of the first DC electric power source 11 and the voltage Vs2 of the second DC electric power source 12 are set to a voltage Vs (Vs1=Vs2=Vs).

Further, the reactance L1 of the first reactor 21 and the reactance L2 of the second reactor 122 are set to a reactance L (L1=L2=L). Further, the length Ta of the period Ta1 in which the state is set to the first state shown in FIG. 4A and the length Tb of the period Tb1 in which the state is set to the second state shown in FIG. 4B are set to a length T (Ta=Tb=T). Additionally, it is assumed that the ratio of the length T of the period Ta1 or the period Tb1 to a switching cycle Tf (refer to FIG. 5) is 0.5 or less (T/Tf<0.5). Then, an amplitude ΔI_1 of the current Is1 that flows through the first DC electric power source 11 and an amplitude ΔI_2 of the current Is2 that flows through the second DC electric power source 12 are expressed by ΔI_1=ΔI_2=Vs×T/L.

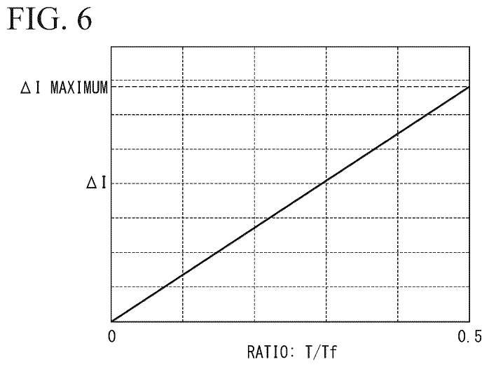

FIG. 6 is a view showing a relationship between an amplitude of a current that flows when the electric power source system 1 is operating in the warming mode and a ratio (T/Tf). With reference to FIG. 6, when the electric power source system 1 is operating in the warming mode, the amplitude ΔI of the current Is1 that flows through the first DC electric power source 11 and the current Is2 that flows through the second DC electric power source 12 is proportional to the ratio (T/Tf). The amplitude ΔI becomes 0 when the ratio (T/Tf) is 0 and becomes maximum when the ratio (T/Tf) is 0.5.

That is, as the ratio of the period Ta2 and the period Tb2 in the switching cycle Tf shown in FIG. 5 is increased, the amplitude ΔI of the current Is1 that flows through the first DC electric power source 11 and the current Is2 that flows through the second DC electric power source 12 are decreased. On the other hand, as the ratio of the period Ta2 and the period Tb2 in the switching cycle Tf shown in FIG. 5 is decreased, the amplitude ΔI of the current Is1 that flows through the first DC electric power source 11 and the current Is2 that flows through the second DC electric power source 12 are increased. Therefore, in order to efficiently warm the first DC electric power source 11 and the second DC electric power source 12, the ratio of the period Ta2 and the period Tb2 in the switching cycle Tf shown in FIG. 5 can be desirably decreased as much as possible.

The switching shown in FIG. 5 is performed, and thereby, a voltage increase operation of the first DC electric power source 11 and a voltage increase operation of the second DC electric power source 12 are alternately performed in a state where at least one of the first DC electric power source 11 and the second DC electric power source 12 is connected between the third node N3 and the fifth node N5. Thereby, since it is possible to cause a high-frequency current to flow through the first DC electric power source 11 and the second DC electric power source 12, it is possible to efficiently warm the first DC electric power source 11 and the second DC electric power source 12.

### <Voltage Balance Mode>

### (1) First Voltage Balance Mode

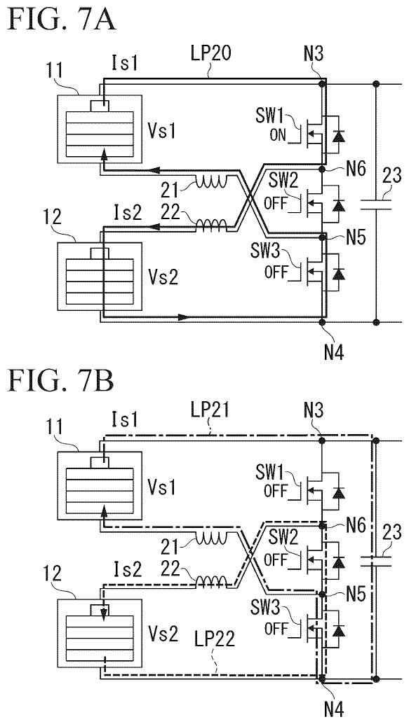

FIG. 7A and FIG. 7B are views showing a current path when the electric power source system 1 is operating in a first voltage balance mode. In FIG. 7A and FIG. 7B, only the configurations necessary for description are shown among the configurations shown in FIG. 1. The first voltage balance mode is performed in order to cause the voltage Vs1 of the first DC electric power source 11 to be equal to the voltage Vs2 of the second DC electric power source 12 when the voltage Vs1 of the first DC electric power source 11 is higher than the voltage Vs2 of the second DC electric power source 12. In the first voltage balance mode, the control device 50 controls the electric power source switching circuit 20 to alternately switch between an energy transfer state shown in FIG. 7A and an energy recovery state shown in FIG. 7B.

In a period in which the electric power source system 1 is operating in the first voltage balance mode, the control device 50 controls each of the first contactor 13, the second contactor 14, the third contactor 15, the fourth contactor 16, the fifth contactor 41, and the sixth contactor 42 to an ON state.

Here, the energy transfer state shown in FIG. 7A is a state in which the first DC electric power source 11 and the second DC electric power source 12 are connected in parallel. The energy recovery state shown in FIG. 7B is a state in which the first DC electric power source 11 is connected via the smoothing capacitor 23, the third switch SW3, and the first reactor 21, and the second DC electric power source 12 is connected to both ends of the second reactor 22.

In the energy transfer state shown in FIG. 7A, electric energy is transferred from the first DC electric power source 11 having a high voltage to the second DC electric power source 12. However, when a voltage difference between the first DC electric power source 11 and the second DC electric power source 12 is large, a peak value Ip of the current that flows through the first DC electric power source 11 and the second DC electric power source 12 becomes large. Therefore, when the magnitude of the current that flows through the first DC electric power source 11 and the second DC electric power source 12 becomes a certain value, the state is shifted to the energy recovery state in order to stop the transfer of electric energy from the first DC electric power source 11 having a high voltage to the second DC electric power source 12.

In the energy recovery state shown in FIG. 7B, in order to lower the increased peak value Ip of the current that flows through the first DC electric power source 11 and the second DC electric power source 12, the electric energy stored in the first reactor 21 and the electric energy stored in the second reactor 22 are recovered by the first DC electric power source 11 and the second DC electric power source 12, respectively. The energy recovery state shown in FIG. 7B is continued until both of the current Is1 that flows through the first DC electric power source 11 and the current Is2 that flows through the second DC electric power source 12 become zero.

As shown in FIG. 7A, the control device 50 sets the state to the energy transfer state described above by performing a control (first control) that sets the first switch SW1 to an ON state and sets the second switch SW2 and the third switch SW3 to an OFF state. In the energy transfer state, a current loop LP20 that passes through the first DC electric power source 11, the first switch SW1, the second reactor 22, the second DC electric power source 12, the third switch SW3, and the first reactor 21 in this order is formed. The current loop LP20 is a current path of a state in which the first DC electric power source 11 and the second DC electric power source 12 are connected in parallel.

As shown in FIG. 7B, the control device 50 sets the state to the energy recovery state described above by performing a control (second control) that sets the first switch SW1, the second switch SW2, and the third switch SW3 to an OFF state. In the energy recovery state, a current loop LP21 that passes through the first DC electric power source 11, the smoothing capacitor 23, the third switch SW3, and the first reactor 21 in this order is formed. Further, a current loop LP22 that passes through the second DC electric power source 12, the third switch SW3, the second switch SW2, and the second reactor 22 in this order is also formed. The current loop LP21 is a current path of a state in which the first DC electric power source 11 is connected to both ends of the first reactor 21, and the current loop LP22 is a current path of a state in which the second DC electric power source 12 is connected to both ends of the second reactor 22.

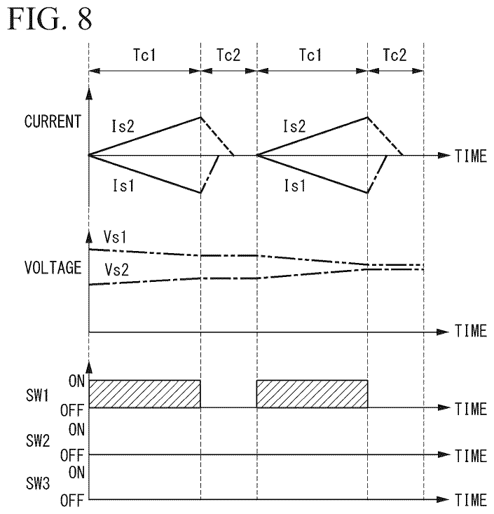

FIG. 8 is a view showing a change in a current when the electric power source system 1 is operating in the first voltage balance mode. In FIG. 8, the period in which the state is set to the energy transfer state shown in FIG. 7A is referred to as a period Tc1, and the period in which the state is set to the energy recovery state shown in FIG. 7B is referred to as a period Tc2. As shown in FIG. 8, the control device 50 controls the electric power source switching circuit 20 to alternately switch between the energy transfer state shown in FIG. 7A and the energy recovery state shown in FIG. 7B.

In the period Tc1 in which the state is set to the energy transfer state shown in FIG. 7A, the current Is1 that flows through the first DC electric power source 11 is decreased, and on the other hand, the current Is2 that flows through the second DC electric power source 12 is increased. When the time from the start of the period Tc1 is t, the current Is2 that flows through the second DC electric power source 12 is expressed by Is2=(Vs1−Vs2)/(L1+L2)×t. When the length of the period Tc1 is tc1, the peak value Ip of the current Is that flows through the first DC electric power source 11 and the second DC electric power source 12 is expressed by Ip=(Vs1−Vs2)/(L1+L2)×t_c1.

In the period Tc2 in which the state is set to the energy recovery state shown in FIG. 7B, both of the current Is1 that flows through the first DC electric power source 11 and the current Is2 that flows through the second DC electric power source 12 are decreased to 0. The time required for the current Is1 that flows through the first DC electric power source 11 to become zero is expressed by Vs1/L1×Ip. Further, the time required for the current Is2 that flows through the second DC electric power source 12 to become zero is expressed by Vs2/L2×Ip. Therefore, a time t_c2 required for both of the current Is1 that flows through the first DC electric power source 11 and the current Is2 that flows through the second DC electric power source 12 to become zero is a larger one of Vs1/L1×Ip and Vs2/L2×Ip.

When the switching shown in FIG. 8 is performed, as shown in the drawing, the voltage Vs1 of the first DC electric power source 11 is gradually decreased, and on the other hand, the voltage Vs2 of the second DC electric power source 12 is gradually increased. Then, the switching shown in FIG. 8 is repeated, and thereby, the voltage Vs1 of the first DC electric power source 11 and the voltage Vs2 of the second DC electric power source 12 become equal to each other. In this way, the control (first voltage balance control) in the first voltage balance mode is performed, and thereby, the voltage Vs1 of the first DC electric power source 11 and the voltage Vs2 of the second DC electric power source 12 become equal to each other.

### (2) Second Voltage Balance Mode

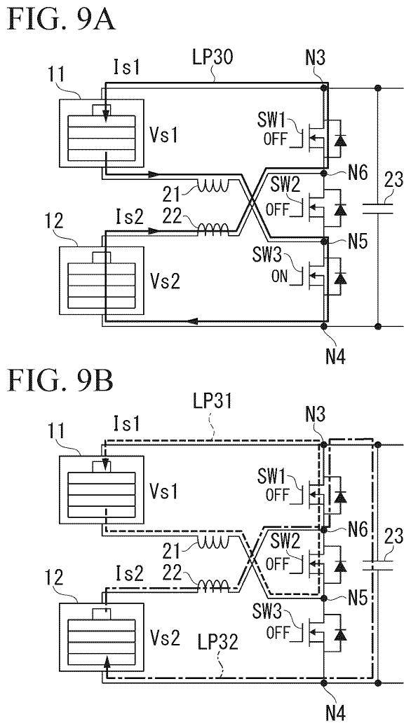

FIG. 9A and FIG. 9B are views showing a current path when the electric power source system 1 is operating in a second voltage balance mode. In FIG. 9A and FIG. 9B, only the configurations necessary for description are shown among the configurations shown in FIG. 1. The second voltage balance mode is performed in order to cause the voltage Vs1 of the first DC electric power source 11 to be equal to the voltage Vs2 of the second DC electric power source 12 when the voltage Vs2 of the second DC electric power source 12 is higher than the voltage Vs1 of the first DC electric power source 11. In the second voltage balance mode, the control device 50 controls the electric power source switching circuit 20 to alternately switch between an energy transfer state shown in FIG. 9A and an energy recovery state shown in FIG. 9B.

Here, the energy transfer state shown in FIG. 9A is a state in which the first DC electric power source 11 and the second DC electric power source 12 are connected in parallel, similarly to the energy transfer state shown in FIG. 9A. The energy recovery state shown in FIG. 9B is a state in which the first DC electric power source 11 is connected to both ends of the first reactor 21, and the second DC electric power source 12 is connected via the second reactor 22, the first switch SW1, and the smoothing capacitor 23.

In the energy transfer state shown in FIG. 9A, electric energy is transferred from the second DC electric power source 12 having a high voltage to the first DC electric power source 11. In the energy recovery state shown in FIG. 9B, in order to lower the increased peak value Ip of the current that flows through the first DC electric power source 11 and the second DC electric power source 12, the electric energy stored in the first reactor 21 and the electric energy stored in the second reactor 22 are recovered by the first DC electric power source 11 and the second DC electric power source 12, respectively.

As shown in FIG. 9A, the control device 50 sets the state to the energy transfer state described above by performing a control (third control) that sets the first switch SW1 and the second switch SW2 to an OFF state and sets the third switch SW3 to an ON state. In the energy transfer state, a current loop LP30 that passes through the first DC electric power source 11, the first reactor 21, the third switch SW3, the second DC electric power source 12, the second reactor 22, and the first switch SW1 in this order is formed. The current loop LP30 is a current path of a state in which the first DC electric power source 11 and the second DC electric power source 12 are connected in parallel.

As shown in FIG. 9B, the control device 50 sets the state to the energy recovery state described above by performing a control (second control) that sets the first switch SW1, the second switch SW2, and the third switch SW3 to an OFF state. In the energy recovery state, a current loop LP31 that passes through the first DC electric power source 11, the first reactor 21, the second switch SW2, and the first switch SW1 in this order is formed. Further, a current loop LP32 that passes through the second DC electric power source 12, the second reactor 22, the first switch SW1, and the smoothing capacitor 23 in this order is also formed. The current loop LP31 is a current path of a state in which the first DC electric power source 11 is connected to both ends of the first reactor 21, and the current loop LP32 is a current path of a state in which the second DC electric power source 12 is connected via the second reactor 22 and the smoothing capacitor 23.

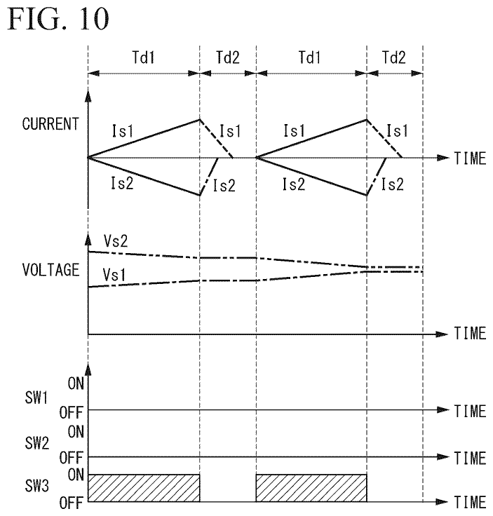

FIG. 10 is a view showing a change in a current when the electric power source system 1 is operating in the second voltage balance mode. In FIG. 10, a period in which the state is set to the energy transfer state shown in FIG. 9A is referred to as a period Td1, and a period in which the state is set to the energy recovery state shown in FIG. 9B is referred to as a period Td2. As shown in FIG. 10, the control device 50 controls the electric power source switching circuit 20 to alternately switch between the energy transfer state shown in FIG. 9A and the energy recovery state shown in FIG. 9B.

In the period Td1 in which the state is set to the energy transfer state shown in FIG. 9A, the current Is2 that flows through the second DC electric power source 12 is decreased, and on the other hand, the current Is1 that flows through the first DC electric power source 11 is increased. When the time from the start of the period Td1 is t, the current Is1 that flows through the first DC electric power source 11 is expressed by Is1=(Vs2−Vs1)/(L1+L2)×t. When the length of the period Td1 is t_d1, the peak value Ip of the current Is that flows through the first DC electric power source 11 and the second DC electric power source 12 is expressed by Ip=(Vs2−Vs1)/(L1+L2)×t_d1.

In the period Td2 in which the state is set to the energy recovery state shown in FIG. 9B, both of the current Is1 that flows through the first DC electric power source 11 and the current Is2 that flows through the second DC electric power source 12 are decreased to 0. A time t_d2 required for both of the current Is1 that flows through the first DC electric power source 11 and the current Is2 that flows through the second DC electric power source 12 to become zero is a larger one of Vs1/L1×Ip and Vs2/L2×Ip similarly to the time t_c2 in the case where the operation is performed in the first voltage balance mode.

When the switching shown in FIG. 10 is performed, as shown in the drawing, the voltage Vs2 of the second DC electric power source 12 is gradually decreased, and on the other hand, the voltage Vs1 of the first DC electric power source 11 is gradually increased. Then, the switching shown in FIG. 10 is repeated, and thereby, the voltage Vs1 of the first DC electric power source 11 and the voltage Vs2 of the second DC electric power source 12 become equal to each other. In this way, the control (second voltage balance control) in the second voltage balance mode is performed, and thereby, the voltage Vs1 of the first DC electric power source 11 and the voltage Vs2 of the second DC electric power source 12 become equal to each other.

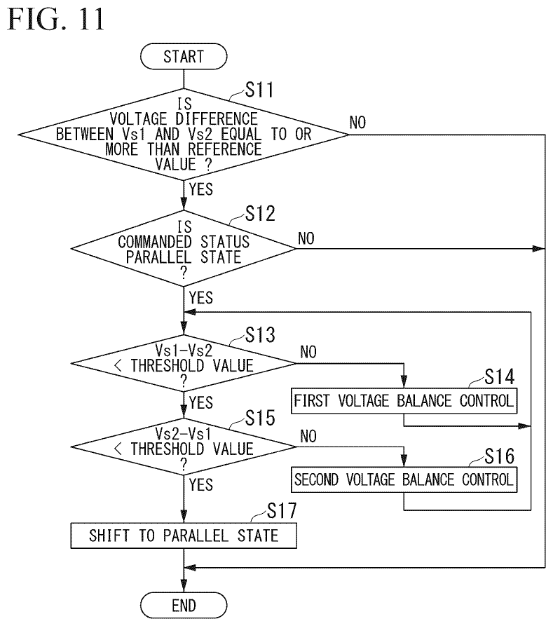

FIG. 11 is a flowchart showing a process when the voltage balance control is performed in the electric power source system 1. The flowchart shown in FIG. 11 is started, for example, each time an upper-level device (not shown) performs a shift command to the parallel connection on the control device 50 of the electric power source system 1. Such a shift command is performed, for example, at the time of start of the electric vehicle.

As shown in FIG. 11, when the process is started, the control device 50 determines whether or not the difference (voltage difference) between the voltage Vs1 of the first DC electric power source 11 detected by the first voltage sensor 17 and the voltage Vs2 of the second DC electric power source 12 detected by the second voltage sensor 18 is equal to or more than a prescribed reference value (Step S11). When the control device 50 determines that the voltage difference is not equal to or more than the reference value, the control device 50 ends the process shown in FIG. 11. On the other hand, when the control device 50 determines that the voltage difference is equal to or more than the reference value, the control device 50 determines whether or not the status commanded from the upper-level device is the parallel state (Step S12).

When the control device 50 determines that the status commanded from the upper-level device is not the parallel state, the control device 50 ends the process shown in FIG. 11. On the other hand, when the control device 50 determines that the status commanded from the upper-level device is the parallel state, the control device 50 determines whether or not a value (hereinafter, referred to as a first potential difference) obtained by subtracting the voltage Vs2 of the second DC electric power source 12 from the voltage Vs1 of the first DC electric power source 11 is smaller than a prescribed threshold value (Step S13).

When the control device 50 determines that the first potential difference is not smaller than the threshold value (is equal to or more than the threshold value), the control device 50 shifts to the first voltage balance mode described with reference to FIG. 7A, FIG. 7B, and FIG. 8 and performs the first voltage balance control (Step S14). The control device 50 performs the first voltage balance control in Step S14 until it is determined in Step S13 that the first potential difference is smaller than the threshold value. On the other hand, when the control device 50 determines that the first potential difference is smaller than the threshold value, the control device 50 determines whether or not a value (hereinafter, referred to as a second potential difference) obtained by subtracting the voltage Vs1 of the first DC electric power source 11 from the voltage Vs2 of the second DC electric power source 12 is larger than a prescribed threshold value (Step S15).

When the control device 50 determines that the second potential difference is not smaller than the threshold value (is equal to or more than the threshold value), the control device 50 shifts to the second voltage balance mode described with reference to FIG. 9A, FIG. 9B, and FIG. 10 and performs the second voltage balance control (Step S16). The control device 50 performs the second voltage balance control in Step S16 until it is determined in Step S15 that the second potential difference is smaller than the threshold value. On the other hand, when the control device 50 determines that the second potential difference is smaller than the threshold value, the control device 50 performs a control of shifting the state to the parallel state shown in FIG. 3 (Step S17). When the above process is completed, the control device 50 ends the process shown in FIG. 11.

### <Fail-Safe Mode>

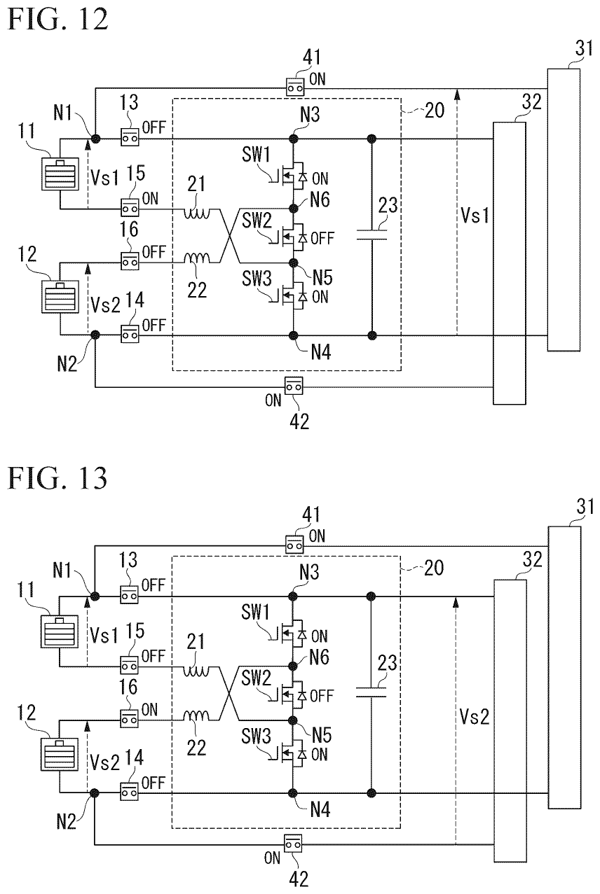

FIG. 12 is a first view showing states of each switch and each contactor when the electric power source system 1 operates in a fail-safe mode. In FIG. 12, only the configurations necessary for description are shown among the configurations shown in FIG. 1. When the control device 50 detects that a failure such as an overcurrent occurs in the first load device 100, the control device 50 shifts to the fail-safe mode and controls each switch and each contactor as shown in FIG. 12.

Specifically, as shown in FIG. 12, in the fail-safe mode, the control device 50 controls the first contactor 13, the second contactor 14, and the fourth contactor 16 to an OFF state, controls the third contactor 15, the fifth contactor 41, and the sixth contactor 42 to an ON state, controls the first switch SW1 and the third switch SW3 to an ON state, and controls the second switch SW2 to an OFF state.

As a result, the potential difference between the first node N1 and the fourth node N4, that is, the input voltage of the first voltage conversion circuit 31 becomes substantially equal to the voltage Vs1 of the first DC electric power source 11. Thereby, even when a failure occurs in the first load device 100, it is possible to continue electric power supply from the first voltage conversion circuit 31 to the second load device 200. Further, the first DC electric power source 11 and the second DC electric power source 12 are electrically disconnected from the first load device 100. As a result, electric power supply to the first load device 100 is stopped, and therefore, it is possible to prevent a large current from flowing in the electric power source system 1.

FIG. 13 is a second view showing states of each switch and each contactor when the electric power source system 1 operates in the fail-safe mode. In FIG. 13, only the configurations necessary for description are shown among the configurations shown in FIG. 1. When the control device 50 detects that a failure such as an overcurrent occurs in the first load device 100, the control device 50 shifts to the fail-safe mode and controls each switch and each contactor as shown in FIG. 13. When the control device 50 shifts to the fail-safe mode, the control device 50 may control each switch and each contactor as shown in FIG. 12 or may control each switch and each contactor as shown in FIG. 13.

Specifically, as shown in FIG. 13, in the fail-safe mode, the control device 50 controls the first contactor 13, the second contactor 14, and the third contactor 15 to an OFF state, controls the fourth contactor 16, the fifth contactor 41, and the sixth contactor 42 to an ON state, controls the first switch SW1 and the third switch SW3 to an ON state, and controls the second switch SW2 to an OFF state.

As a result, the potential difference between the third node N3 and the second node N2, that is, the input voltage of the second voltage conversion circuit 32 becomes substantially equal to the voltage Vs2 of the second DC electric power source 12. Thereby, even when a failure occurs in the first load device 100, it is possible to continue electric power supply from the second voltage conversion circuit 32 to the second load device 200. Further, the first DC electric power source 11 and the second DC electric power source 12 are electrically disconnected from the first load device 100. As a result, electric power supply to the first load device 100 is stopped, and therefore, it is possible to prevent a large current from flowing in the electric power source system 1.

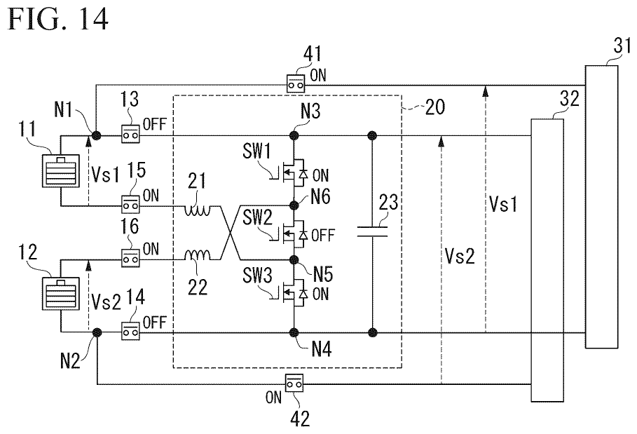

FIG. 14 is a third view showing states of each switch and each contactor when the electric power source system 1 operates in the fail-safe mode. In FIG. 14, only the configurations necessary for description are shown among the configurations shown in FIG. 1. When the control device 50 detects that a failure such as an overcurrent occurs in the first load device 100, the control device 50 shifts to the fail-safe mode and controls each switch and each contactor as shown in FIG. 14. When the control device 50 shifts to the fail-safe mode, the control device 50 may control each switch and each contactor as shown in FIG. 12 or FIG. 13 or may control each switch and each contactor as shown in FIG. 14.

Specifically, as shown in FIG. 14, in the fail-safe mode, the control device 50 controls the first contactor 13 and the second contactor 14 to an OFF state, controls the third contactor 15, the fourth contactor 16, the fifth contactor 41, and the sixth contactor 42 to an ON state, controls the first switch SW1 and the third switch SW3 to an ON state, and controls the second switch SW2 to an OFF state.

As a result, the potential difference between the first node N1 and the fourth node N4, that is, the input voltage of the first voltage conversion circuit 31 becomes substantially equal to the voltage Vs1 of the first DC electric power source 11, and the potential difference between the third node N3 and the second node N2, that is, the input voltage of the second voltage conversion circuit 32 becomes substantially equal to the voltage Vs2 of the second DC electric power source 12. Thereby, even when a failure occurs in the first load device 100, it is possible to continue electric power supply from the first voltage conversion circuit 31 or the second voltage conversion circuit 32 to the second load device 200. Further, the first DC electric power source 11 and the second DC electric power source 12 are electrically disconnected from the first load device 100. As a result, electric power supply to the first load device 100 is stopped, and therefore, it is possible to prevent a large current from flowing in the electric power source system 1.

As described above, in the fail-safe mode, the control device 50 controls each switch and each contactor as shown in FIG. 12, FIG. 13, or FIG. 14, and thereby, even when a failure such as an overcurrent occurs in the first load device 100, it is possible to continue electric power supply to the second load device 200 while preventing a circuit component in the electric power source system 1 from being damaged.

As described above, the electric power source system 1 according to the present embodiment includes: the first DC electric power source 11 having the positive electrode terminal connected to the first node N1; the second DC electric power source 12 having the negative electrode terminal connected to the second node N2; the first contactor 13 connected between the first node N1 and the third node N3; the second contactor 14 connected between the second node N2 and the fourth node N4; the third contactor 15 connected between the negative electrode terminal of the first DC electric power source 11 and the fifth node N5; the fourth contactor 16 connected between the positive electrode terminal of the second DC electric power source 12 and the sixth node N6; the first switch SW1 connected between the third node N3 and the sixth node N6; the second switch SW2 connected between the fifth node N5 and the sixth node N6; the third switch SW3 connected between the fourth node N4 and the fifth node N5; the first voltage conversion circuit 31 connected between the first node N1 and the fourth node N4; and the second voltage conversion circuit 32 connected between the second node N2 and the third node N3.

According to the present embodiment as described above, for example, even when a failure such as an overcurrent occurs in the first load device 100 connected between the third node N3 and the fourth node N4, at least one of the first voltage conversion circuit 31 and the second voltage conversion circuit 32 can continue to operate, and therefore, it is possible to continue to maintain electric power supply from the electric power source system 1.

In the present embodiment, the electric power source system 1 further includes: the fourth switch 33 connected between the seventh node N7 and the output terminal of the first voltage conversion circuit 31; and the fifth switch 34 connected between the seventh node N7 and the output terminal of the second voltage conversion circuit 32.

According to the present embodiment as described above, even when any one of the first voltage conversion circuit 31 and the second voltage conversion circuit 32 fails, for example, it is possible to continue to supply electric power to the second load device 200 connected to the seventh node N7.

In the present embodiment, the electric power source system 1 further includes: the fifth contactor 41 connected between the first node N1 and the first voltage conversion circuit 31, and the rating of the fifth contactor 41 is smaller than that of the first contactor 13.

According to the present embodiment as described above, since the wiring that connects the first node N1 to the first voltage conversion circuit 31 is a wiring dedicated to an electric power source used for the control device 50, the rating of the fifth contactor 41 provided on the wiring can be lower than that of a contactor used for a large electric power load such as a motor. Thereby, it is possible to realize reduction of the size and reduction of the cost of the electric power source system 1.

In the present embodiment, the electric power source system 1 further includes: the sixth contactor 42 connected between the second node N2 and the second voltage conversion circuit 32, wherein the rating of the sixth contactor 42 is smaller than that of the second contactor 14.

According to the present embodiment as described above, since the wiring that connects the second node N2 to the second voltage conversion circuit 32 is a wiring dedicated to an electric power source used for the control device 50, the rating of the sixth contactor 42 provided on the wiring can be lower than that of a contactor used for a large electric power load such as a motor. Thereby, it is possible to realize reduction of the size and reduction of the cost of the electric power source system 1.

In the present embodiment, the electric power source system 1 further includes: the control device 50, wherein when the control device 50 detects that a failure occurs in the first load device 100 connected between the third node N3 and the fourth node N4, the control device 50 controls the first contactor 13, the second contactor 14, and the fourth contactor 16 to an OFF state, controls the third contactor 15 to an ON state, controls the first switch SW1 and the third switch SW3 to an ON state, and controls the second switch SW2 to an OFF state.

According to the present embodiment as described above, even when a failure such as an overcurrent occurs in the first load device 100 connected between the third node N3 and the fourth node N4, the first voltage conversion circuit 31 can continue to operate while electrically disconnecting the first DC electric power source 11 and the second DC electric power source 12 from the first load device 100.

In the present embodiment, the electric power source system 1 further includes: the control device 50, wherein when the control device 50 detects that a failure occurs in the first load device 100 connected between the third node N3 and the fourth node N4, the control device 50 controls the first contactor 13, the second contactor 14, and the third contactor 15 to an OFF state, controls the fourth contactor 16 to an ON state, controls the first switch SW1 and the third switch SW3 to an ON state, and controls the second switch SW2 to an OFF state.

According to the present embodiment as described above, even when a failure such as an overcurrent occurs in the first load device 100 connected between the third node N3 and the fourth node N4, the second voltage conversion circuit 32 can continue to operate while electrically disconnecting the first DC electric power source 11 and the second DC electric power source 12 from the first load device 100.

In the present embodiment, the electric power source system 1 further includes: the control device 50, wherein when the control device 50 detects that a failure occurs in the first load device 100 connected between the third node N3 and the fourth node N4, the control device 50 controls the first contactor 13 and the second contactor 14 to an OFF state, controls the third contactor 15 and the fourth contactor 16 to an ON state, controls the first switch SW1 and the third switch SW3 to an ON state, and controls the second switch SW2 to an OFF state.

According to the present embodiment as described above, even when a failure such as an overcurrent occurs in the first load device 100 connected between the third node N3 and the fourth node N4, both of the first voltage conversion circuit 31 and the second voltage conversion circuit 32 can continue to operate while electrically disconnecting the first DC electric power source 31 and the second DC electric power source 32 from the first load device 100.

Although an embodiment of the present invention has been described, the present invention is not limited to the embodiment described above, and various modifications and substitutions can be made without departing from the scope of the present invention.

For example, the above embodiment is described using an example in which the first reactor 21 is arranged between the third contactor 15 and the fifth node N5, and the second reactor 22 is arranged between the fourth contactor 16 and the sixth node N6. However, the first reactor 22 may be arranged between the first contactor 13 and the third node N3. Further, the second reactor 22 may be arranged between the second contactor 14 and the fourth node N4.

Further, the control device 50 can be realized by a computer such as an embedded computer. When the control device 50 is realized by a computer, functions of each unit included in the control device 50 are realized by a program for realizing the functions being executed by a CPU (central processing unit) provided on the computer. That is, the functions of each unit included in the control device 50 are realized by cooperation of software and hardware resources. The control device 50 may be realized by using hardware such as an FPGA (Field-Programmable Gate Array), an LSI (Large Scale Integration), or an ASIC (Application Specific Integrated Circuit).

What is claimed is:

1. An electric power source system comprising:
a first DC electric power source having a positive electrode terminal connected to a first node;
a second DC electric power source having a negative electrode terminal connected to a second node;
a first contactor connected between the first node and a third node;
a second contactor connected between the second node and a fourth node;
a third contactor connected between a negative electrode terminal of the first DC electric power source and a fifth node;
a fourth contactor connected between a positive electrode terminal of the second DC electric power source and a sixth node;
a first switch connected between the third node and the sixth node;
a second switch connected between the fifth node and the sixth node;
a third switch connected between the fourth node and the fifth node;
a first voltage conversion circuit connected between the first node and the fourth node; and
a second voltage conversion circuit connected between the second node and the third node.

2. The electric power source system according to claim 1, further comprising:
a fourth switch connected between a seventh node and an output terminal of the first voltage conversion circuit; and
a fifth switch connected between the seventh node and an output terminal of the second voltage conversion circuit.

3. The electric power source system according to claim 1, further comprising:
a fifth contactor connected between the first node and the first voltage conversion circuit,
wherein a rating of the fifth contactor is smaller than a rating of the first contactor.

4. The electric power source system according to claim 1, further comprising:
a sixth contactor connected between the second node and the second voltage conversion circuit,
wherein a rating of the sixth contactor is smaller than a rating of the second contactor.

5. The electric power source system according to claim 1, further comprising:
a control device,
wherein when the control device detects that a failure occurs in a first load device connected between the third node and the fourth node, the control device controls the first contactor, the second contactor, and the fourth contactor to an OFF state, controls the third contactor to an ON state, controls the first switch and the third switch to an ON state, and controls the second switch to an OFF state.

6. The electric power source system according to claim 1, further comprising:
a control device,
wherein when the control device detects that a failure occurs in a first load device connected between the third node and the fourth node, the control device controls the first contactor, the second contactor, and the third contactor to an OFF state, controls the fourth contactor to an ON state, controls the first switch and the third switch to an ON state, and controls the second switch to an OFF state.

7. The electric power source system according to claim 1, further comprising:
a control device,
wherein when the control device detects that a failure occurs in a first load device connected between the third node and the fourth node, the control device controls the first contactor and the second contactor to an OFF state, controls the third contactor and the fourth contactor to an ON state, controls the first switch and the third switch to an ON state, and controls the second switch to an OFF state.
